(19) United States
(12) Patent Application Publication
(10) Pub. No.: US 2020/0006718 A1
(43) Pub. Date: Jan. 2, 2020

(54) ALL-SOLID STATE SECONDARY BATTERY AND MANUFACTURING METHOD THEREFOR

(71) Applicant: FUJIFILM Corporation, Tokyo (JP)

(72) Inventor: Shinji IMAI, Ashigarakami-gun (JP)

(73) Assignee: FUJIFILM Corporation, Tokyo (JP)

(21) Appl. No.: 16/566,960

(22) Filed: Sep. 11, 2019

Related U.S. Application Data
(63) Continuation of application No. PCT/JP2018/008325, filed on Mar. 5, 2018.

(30) Foreign Application Priority Data
Mar. 13, 2017 (JP) 2017-047773

(51) Int. Cl. H01M 2/02; H01M 10/0587; H01M 10/0562; H01M 10/0525

(52) U.S. Cl. CPC H01M 2/0267; H01M 10/0525; H01M 10/0562; H01M 10/0587

(57) ABSTRACT

Provided are an all-solid state secondary battery having a battery element member having a collector, a solid electrolyte layer, and a positive electrode active material layer, an axial core having the battery element member disposed on a side surface outer circumference, and a battery exterior body that is configured to store the battery element member and the axial core, in which a reinforcement coating body is provided on the side surface outer circumference of the battery exterior body, and, in a discharged state, a compressive stress of 0.5 MPa or more at 25° C. is provided between the axial core and the battery exterior body and between the battery exterior body and the battery element member; and a manufacturing method therefor.

### CROSS-REFERENCE TO RELATED APPLICATIONS

This application is a Continuation of PCT International Application No. PCT/JP2018/008325 filed on Mar. 5, 2018, which claims priority under 35 U.S.C. § 119 (a) to Japanese Patent Application No. 2017-047773 filed in Japan on Mar. 13, 2017. Each of the above applications is hereby expressly incorporated by reference, in its entirety, into the present application.

### BACKGROUND OF THE INVENTION

### 1. Field of the Invention

The present invention relates to an all-solid state secondary battery and a manufacturing method therefor.

### 2. Description of the Related Art

A lithium ion secondary battery is a storage battery which has a negative electrode, a positive electrode, and an electrolyte interposed between the negative electrode and the positive electrode and enable charging and discharging by the reciprocal migration of lithium ions between both electrodes. In the related art, an organic electrolytic solution has been used as the electrolyte in lithium ion secondary batteries. However, organic electrolytic solutions are likely to cause liquid leakage, have a concern of the occurrence of a short circuit and ignition in batteries due to overcharging or overdischarging, and are demanded to further improve in terms of safety and reliability.

Under the above-described circumstances, active development of all-solid state secondary batteries in which a non-flammable inorganic solid electrolyte is used instead of the organic electrolytic solution is underway. In all-solid state secondary batteries, all of the negative electrode, the electrolyte, and the positive electrode consist of a solid, safety and reliability which are considered as a problem of batteries in which the organic electrolytic solution is used can be significantly improved, and it also becomes possible to extend service lives.

In lithium ion secondary batteries, during charging, electrons migrate from the positive electrode to the negative electrode, at the same time, lithium ions are released from a lithium oxide or the like that configures the positive electrode, and these lithium ions reach the negative electrode through the electrolyte and are accumulated in the negative electrode. A phenomenon in which some of the lithium ions accumulated in the negative electrode as described above capture electrons and are precipitated as metallic lithium.

A technique for causing the precipitate of this metallic lithium to function as a negative electrode active material is known. For example, JP2011-159596A describes that a secondary battery in which a negative electrode active material layer is not formed on a negative electrode collector during the assembly of the battery, and an alkali metal or an alkali earth metal that is supplied from the positive electrode side during charging is precipitated on the negative electrode collector.

### SUMMARY OF THE INVENTION

The technique described in JP2011-159596A is to precipitate metal on the negative electrode collector and cause the metal to function as a negative electrode. However, it has been known that metal that is precipitated on the negative electrode collector grows in a dendrite shape and thus there is a concern that, in a case where the all-solid state secondary battery is repeatedly charged and discharged, dendrites may grow, a void may be generated between the precipitated metal and the negative electrode collector, the resistance may slowly increase, and the service life may be shortened.

Furthermore, it has been known that there is a case where the dendrites are precipitated, for example, several tens of micrometers in length, and, in this case, there is a concern that a battery exterior body may not be capable of withstanding the expansion of the volume and the battery exterior body may break (crack). The all-solid state secondary battery is likely to receive a crush load and cause the battery exterior body to deform and to allow moisture to intrude into the battery. In a case where a sulfide-based electrolyte is used as the solid electrolyte, there is a concern that the moisture and the electrolyte may react with each other to generate toxic hydrogen sulfide.

An object of the present invention is to provide an all-solid state secondary battery capable of plastically deforming metal that is precipitated on a negative electrode collector during charging to favorably hold the contact between the precipitated metal and the negative electrode collector and capable of suppressing the deterioration of the electrical resistance. In addition, another object of the present invention is to provide an all-solid state secondary battery in which metal is precipitated on a negative electrode collector during charging and is caused to function as a negative electrode active material layer and the breakage of a battery exterior body can be prevented by effectively the expansion of the battery caused by the precipitated metal on the surface of the negative electrode collector. Furthermore, still another object of the present invention is to provide a method for manufacturing an all-solid state secondary battery suitable for the manufacturing of the all-solid state secondary battery.

The above-described objects of the present invention were achieved by the following means.

[1] An all-solid state secondary battery comprising:

a battery element member having a collector, a solid electrolyte layer, and a positive electrode active material layer;

an axial core having the battery element member disposed on a side surface outer circumference; and

a battery exterior body that is configured to store the battery element member and the axial core,

in which a reinforcement coating body is provided on the side surface outer circumference of the battery exterior body, and,

in a discharged state, a compressive stress of 0.5 MPa or more at 25° C. is provided between the axial core and the battery element member and between the battery exterior body and the battery element member.

[2] The all-solid state secondary battery according to [1], in which the reinforcement coating body has a carbon fiber.

[3] The all-solid state secondary battery according to [1] or [2], in which the reinforcement coating body is wound around the side surface outer circumference of the battery exterior body.

[4] The all-solid state secondary battery according to any one of [1] to [3], in which an inner diameter of the reinforcement coating body is constant from a battery positive electrode side through a battery negative electrode side, and a width of the reinforcement coating body in a longitudinal direction of the axial core is longer than a width of the battery element member.

[5] The all-solid state secondary battery according to any one of [1] to [4], in which the axial core includes a carbon material.

[6] The all-solid state secondary battery according to any one of [1] to [5], in which the solid electrolyte layer and/or the positive electrode active material layer contain sulfur and/or modified sulfur.

[7] A method for manufacturing the all-solid state secondary battery according to [6], the method comprising:

(a) a step of disposing the battery element member in the battery exterior body;

(b) a step of disposing the reinforcement coating body on the side surface outer circumference of the battery exterior body; and

(c) a step of heating the battery exterior body on which the reinforcement coating body is disposed in a temperature range of 200° C. or lower to thermally fuse the sulfur and/or the modified sulfur.

[8] The method for manufacturing the all-solid state secondary battery according to [7], in which the heating is carried out after the battery element member is shaped to a cylindrical shape.

In the present invention, numerical ranges expressed using “to” include numerical values before and after “to” as the lower limit value and the upper limit value.

In the all-solid state secondary battery of the present invention, metal is precipitated on the collector under a compressive stress of 0.5 MPa or more, and thus the precipitated metal plastically deforms, and the adhesion to the collector is maintained. As a result, an increase in the electrical resistance is suppressed, and the battery service life improves. In addition, the all-solid state secondary battery of the present invention is capable of preventing the breakage (cracking) of the battery exterior body by effectively suppressing the expansion of the battery caused by the precipitated metal on the surface of the negative electrode collector. In addition, even in a case where cracks are generated, the propagation of the cracks can he prevented.

In addition, according to the method for manufacturing an all-solid state secondary battery of the present invention, it is possible to obtain the all-solid state secondary battery of the present invention having the above-described effects.

The above-described and other characteristics and advantages of the present invention will be further clarified by the following description and the accompanying drawings.

### BRIEF DESCRIPTION OF THE DRAWINGS

FIG. 1 is a vertical cross-sectional view schematically showing a basic configuration of an ordinary all-solid state secondary battery.

FIG. 2 is a vertical cross-sectional view schematically showing a cylindrical all-solid state secondary battery according to a preferred embodiment of the present invention and an enlarged cross-sectional view of an A portion in FIG. 2.

### DESCRIPTION OF THE PREFERRED EMBODIMENTS

An all-solid state secondary battery of an embodiment of the present invention achieves the above-described objects by providing a reinforcement coating body on a side surface outer circumference of a battery exterior body so as to generate a compressive stress of 0.5 MPa or more between an axial core and a battery element member and between the battery exterior body and the battery element member.

Hereinafter, a preferred embodiment of the present invention will be described.

[All-Solid State Secondary Battery]

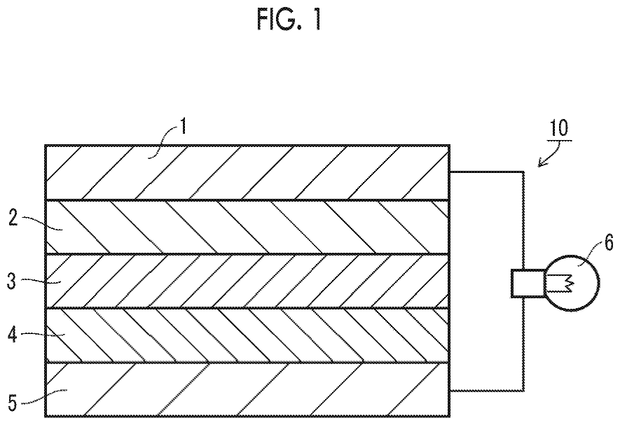

FIG. 1 shows the basic configuration of an ordinary all-solid state secondary battery. As shown in FIG. 1, an all-solid state secondary battery 10 of the embodiment of the present invention has a structure in which, in the case of being seen from a negative electrode side, a negative electrode collector 1, a negative electrode active material layer 2, a solid electrolyte layer 3, a positive electrode active material layer 4, and a positive electrode collector 5 are laminated in this order. In the respective layers, adjacent layers are in direct contact with each other.

Due to the above-described structure, during charging, electrons (e) are supplied to the negative electrode side, and, at the same time, an alkali metal or an alkali earth metal that configures a positive electrode active material is ionized. Ionized ions migrate through the solid electrolyte layer 3 and are accumulated in a negative electrode. For example, in a lithium ion secondary battery, lithium ions (Li⁺) are accumulated in the negative electrode.

During discharging, the alkali metal ions or the alkali earth metal ions accumulated in the negative electrode return to a positive electrode side, and electrons are supplied to an operation portion 6. In the example shown in the drawing, an electric bulb is employed as the operation portion 6 and is lit by discharging.

In addition, the all-solid state secondary battery may be formed to have the solid electrolyte layer 3 and the negative electrode collector 1 in direct contact with each other without having the negative electrode active material layer 2. In this form of the all-solid state secondary battery, a phenomenon in which, during charging, some of alkali metal ions or alkali earth metal ions accumulated in a negative electrode bond to electrons and are precipitated on the surface of the negative electrode collector as metal is used. That is, in this form of the all-solid state secondary battery, metal precipitated on the surface of the negative electrode is made to function as a negative electrode active material layer. For example, metallic lithium is considered to have a theoretical capacity 10 or more times that of graphite that is generally used as a negative electrode active material. Therefore, in a form in which metallic lithium is precipitated in a negative electrode and a solid electrolyte layer is pressed to the precipitated metallic lithium, it is possible to form a layer of metallic lithium on the surface of a collector, and it becomes possible to realize a secondary battery having a high energy density.

In addition, in an all-solid state secondary battery from which a negative electrode active material layer is removed, the thickness of the battery becomes thin, and thus there is an advantage that, in a case where the battery is wound in a roll shape, it becomes possible to further suppress the generation of fissures or the like in a solid electrolyte layer.

Meanwhile, the all-solid state secondary battery having no negative electrode active material layer in the present invention simply implies that the negative electrode active material layer is not formed in a layer-forming step during the manufacturing of the battery. In addition, as described above, a negative electrode active material layer is formed between the solid electrolyte layer and the negative electrode collector due to charging.

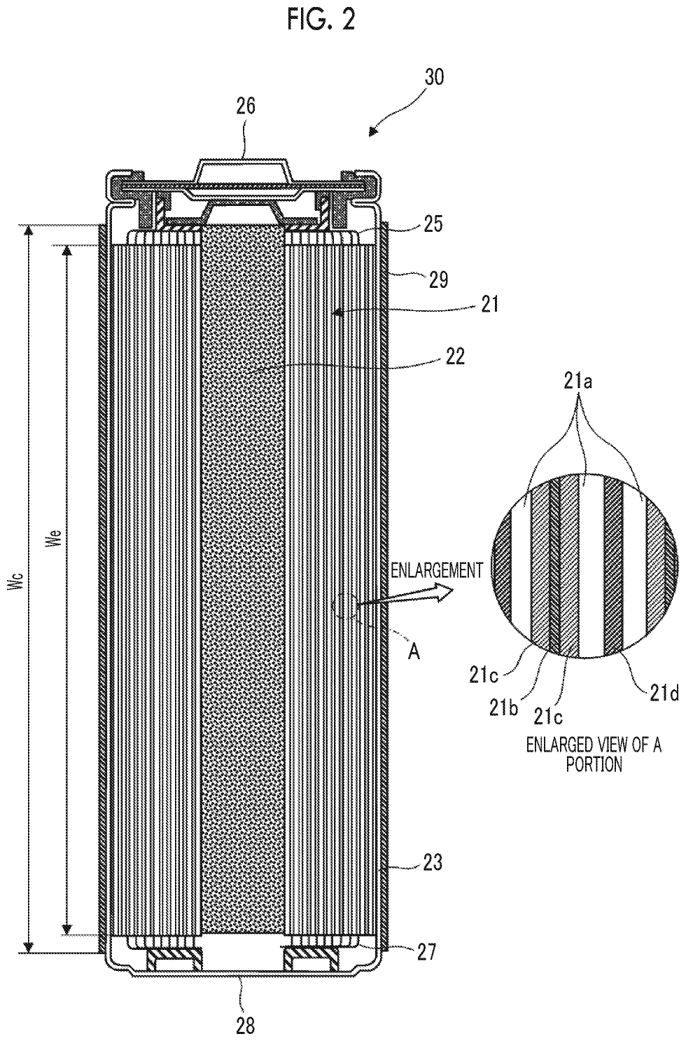

FIG. 2 shows a preferred form of the all-solid state secondary battery of the embodiment of the present invention. As shown in FIG. 2, a cylindrical all-solid state secondary battery 30 is a battery in which a configuration not having the negative electrode active material layer in the above-described layer configuration is realized in a cylindrical form. In the cylindrical all-solid state secondary battery 30, a battery element member 21 having a laminate structure consisting of a collector, a solid electrolyte layer, and a positive electrode active material layer as a basic unit is disposed in a laminate shape around an axial core 22. That is, the battery element member 21 has at least a negative electrode collector 21d, a solid electrolyte layer 21a, a positive electrode active material layer 21c, and a positive electrode collector 21b. Meanwhile, in the form shown in FIG. 2, multiple power generation elements in which the negative electrode collector 21d, the solid electrolyte layer 21a, the positive electrode active material layer 21c, the positive electrode collector 21b, the positive electrode active material layer 21c, and the solid electrolyte layer 21a are laminated in this order are overlaid, thereby configuring the battery element member 21. In this cylindrical all-solid state secondary battery 30, two adjacent power generation elements share one collector. That is, the solid active layers are provided on both surfaces of one collector, and the positive electrode active material layers are provided on both surface of one collector. In addition, the description of FIG. 2 is about a configuration during the assembly of the battery, and, after the manufacturing of the battery, a negative electrode active material layer consisting of precipitated metal is formed between the negative electrode collector 21d and the solid electrolyte layer 21a. That is, “the battery element member having the collector, the solid electrolyte layer, and the positive electrode active material layer” in the present invention refers to a form configured of a negative electrode collector, a solid electrolyte layer, a positive electrode active material layer, and a positive electrode collector. In addition, “the battery element member” also refers to a form configured of a negative electrode collector, a negative electrode active material (precipitated metal), a solid electrolyte layer, a positive electrode active material layer, and a positive electrode collector.

In addition, the cylindrical all-solid state secondary battery 30 comprises a battery exterior body 23 that serves as a battery container into which the battery element member 21 is inserted.

Furthermore, a reinforcement coating body 29 is disposed on a side surface outer circumference of the battery exterior body 23.

In addition, furthermore, the positive electrode collector 21b in the battery element member 21 is connected to a battery positive electrode 26 through a positive electrode tab 25 that electrically connects the positive electrode collector and the battery positive electrode, and the negative electrode collector 21d in the battery element member 21 is connected to a battery negative electrode 28 through a negative electrode tab 27 that electrically connects the negative electrode collector and the battery negative electrode.

In the all-solid state secondary battery of the embodiment of the present invention, the thicknesses of the positive electrode active material layer and the negative electrode active material layer are not particularly limited. In a case where the dimensions of an ordinary battery are taken into account, the thicknesses of the respective layers are preferably 10 to 1,000 μm and more preferably 20 μm or more and less than 500 μm.

In the present specification, the solid electrolyte layer includes an inorganic solid electrolyte and may further contain an active material. The inorganic solid electrolyte that configures the solid electrolyte layer or the combination of the inorganic solid electrolyte and the active material that configure the solid electrolyte layer will be referred to as the inorganic solid electrolyte material. In addition, the active material refers to a positive electrode active material and/or a negative electrode active material. The solid electrolyte layer, generally, does not include the active material.

To the positive electrode active material layer, a positive electrode active material is added.

<Reinforcement Coating Body>

The reinforcement coating body 29 is disposed so as to provide a compressive stress of 0.5 MPa or more at 25° C. between the axial core 22 and the battery element member 21 and between the battery exterior body 23 and the battery element member 21 and press the battery exterior body 23 toward the inside in a discharged state of the all-solid state secondary battery 30.

For example, as the reinforcement coating body 29, it is preferable to use a material having a smaller thermal expansion coefficient than the battery exterior body 23. Generally, in a case where the all-solid state secondary battery 30 is repeatedly charged and discharged and thus heat is generated, the battery exterior body 23 expands due to the heat. However, the reinforcement coating body 29 has a smaller thermal expansion coefficient than the battery exterior body 23, and thus the side surface outer circumference of the battery exterior body 23 is pressed in the inside direction by the reinforcement coating body 29, and thus it becomes possible to suppress the expansion of the battery exterior body 23.

Specifically, the reinforcement coating body 29 preferably has a carbon fiber and more preferably consists of a carbon fiber disposed on the side surface outer circumference of the battery exterior body 23. For example, the reinforcement coating body is preferably configured by winding a carbon fiber filament that is a bundle of monofilaments of a carbon fiber.

[Method for Measuring Compressive Stress]

The compressive stress can be measured by interposing a prescale sheet, two-sheet type, for super low pressure (LLW), of a pressure measurement film (PRESCALE (registered trademark)) (manufactured by Fujifilm Corporation) between the battery exterior body and the reinforcement coating body.

As the carbon fiber, a polyacrylonitrile (PAN)-based carbon fiber and a pitch-based carbon fiber are exemplified. The PAN-based carbon fiber is preferably used in a filament state in which the diameter of a monofilament is 5 to 7 μm and approximately 1,000 to 24,000 monofilaments are bundled together. The pitch-based carbon fiber is preferably used in a filament state in which the diameter of a monofilament is 7 to 10 μm and approximately 1,000 to 24,000 monofilaments are bundled together.

Regarding the winding start point of the carbon fiber filament, the winding start end of the carbon fiber filament is tied to the metal side surface outer circumference end portion of the battery exterior body using a stainless steel wire, and the tied portion is fixed using an instant adhesive. In addition, regarding the end point of the winding of the carbon fiber filament, the winding end of the carbon fiber filament is tied to the metal side surface outer circumference end portion of the battery exterior body using a stainless steel wire, and the tied portion is fixed using an instant adhesive. The carbon fiber has a tensile strength of approximately 1 GPa at 25° C. and thus can be strongly wound during winding to an extent to which the battery exterior body 23 is not crushed. For example, a carbon fiber TORAYCA (registered trademark) T800S (trade name) manufactured by Toray Industries, Inc. has a tensile strength of 5.9 GPa (catalog value), and TORAYCA T1000G (trade name) has a tensile strength of 6.4 GPa (catalog value). As described above, the carbon fiber has a tensile strength approximately eight or more times that of carbon steel. That is, the tensile strength of carbon steel 5550 is approximately 0.75 GPa. For example, the tension (tightening force) of the wound carbon fiber filament is 0.1 N or more and 1,000 N or less, preferably 1 N or more and 300 N or less, and more preferably 3 N or more and 100 N or less. In a case where the tension of winding is too strong, there is a concern that the battery exterior body 23 may deform, and, in a case where the tension of winding is too weak, there is a concern that the wound carbon fiber filament may become loose and deviate. The above-described carbon fiber filament has a diameter large enough to withstand tension even in the case of being wound around the side surface outer circumference of the battery exterior body 23 in the above-described tension range. For example, the diameter of the carbon fiber filament is 0.01 mm to 1.0 mm, preferably 0.1 mm to 0.7 mm, and more preferably 0.2 mm to 0.5 mm. The above-described carbon fiber filament is wound around the side surface outer circumference of the battery exterior body 23 and configures the reinforcement coating body 29. In a case where the carbon fiber filament is wound as described above, it is possible to evenly suppress an internal pressure that is applied to the battery exterior body 23. In addition, the carbon fiber filament is preferably wound without any voids. In a case where the carbon fiber filament is wound without any voids as described above, it is possible to evenly suppress pressure that is applied to the battery exterior body 23. In addition, the carbon fiber filament may also be wound in multiple layers.

The carbon fiber that configures the carbon fiber filament generally has a negative thermal expansion coefficient. That is, at approximately 200° C. or lower, the carbon fiber has a property of contracting as the temperature increases. The thermal expansion coefficient is approximately a maximum of −4×10⁻⁶/K; however, in a case where the repetition of charging and discharging increases the internal temperature of the all-solid state secondary battery, the reinforcement coating body 29 of the carbon fiber filament contracts due to heat. As described above, the reinforcement coating body 29 does not thermally expand, even in a case where an outward force is applied to the battery exterior body 23 from the inside due to the internal pressure of the all-solid state secondary battery, the outward force is suppressed by the reinforcement coating body 29. As a result, it is possible to prevent the generation of fissures in the battery exterior body 23 or the breakage of the battery exterior body 23 by pressure.

In addition, due to the reinforcement coating body 29, it is possible to suppress a void that tends to be generated between the negative electrode collector 21d and the solid electrolyte layer 21a by dendrites. Furthermore, it is possible to suppress an internal pressure that is applied to the battery exterior body 23 caused by dendrites that are precipitated in the negative electrode during charging. As a result, it is possible to extend the battery service life.

The reinforcement coating body 29 may consist of tape including a carbon fiber that is wound without any voids so as to be overlaid on the side surface outer circumference of the battery exterior body 23. This tape preferably consists of carbon fiber reinforced plastic (CFRP) tape. This tape preferably consists of CFRP tape wound without any voids so as to be overlaid on the side surface outer circumference of the battery exterior body 23 so as to evenly support the internal pressure that is applied to the battery exterior body 23.

The reinforcement coating body 29 may also consist of a CFRP sheet wound around the side surface outer circumference of the battery exterior body 23. In addition, the reinforcement coating body 29 may also consist of a cylindrical CFRP or glass fiber reinforced polymer (GFRP) body fitted onto the side surface outer circumference of the battery exterior body 23.

A width We of the reinforcement coating body 29 in the longitudinal direction of the axial core 22 is preferably longer than a width We of the battery element member 21. Because the width We of the reinforcement coating body 29 is longer than the width We of the battery element member 21, it is possible to evenly support the inside pressure of the battery in the width direction of the battery element member 21, and thus the above-described effect can be exhibited.

According to the all-solid state secondary battery 30, it is possible to suppress the generation of a void that tends to be generated between the negative electrode collector 21d and the solid electrolyte layer 21a by dendrites generated in the solid electrolyte layer 21a using the reinforcement coating body 29. In addition, it is possible to suppress the internal pressure that is applied to the battery exterior body 23 caused by dendrites that are precipitated in the negative electrode during charging. As a result, it is possible to prevent the generation of fissures in the battery exterior body 23 or the breakage of the battery exterior body 23 by pressure, and thus the battery service life is extended. In addition, it becomes difficult for cracks to be generated in the battery exterior body 3, and, even in a case where cracks are generated, the cracks are blocked by the reinforcement coating body 29, and thus the reaction between an electrolyte and moisture that is caused by the intrusion of the moisture into the battery does not occur. Therefore, the generation of hydrogen sulfide (H₂S) in the battery is suppressed.

<Axial Core>

A carbon material is preferably included in the axial core 22. The use of the carbon material reduces the weight of the all-solid state secondary battery 30. As the carbon material, a carbon rod obtained by solidifying activated carbon powder is exemplified.

In the all-solid state secondary battery 30, the axial core 22 is disposed in an axial direction in the battery, and the reinforcement coating body 29 that imparts stress in an inside direction to the outermost circumference is disposed. Therefore, it becomes easy to generate a compressive stress of 0.5 kPa or more between the axial core 22 and a battery element member 21 and between the battery element member 21 and the battery exterior body 23. That is, the compressive force in the inside direction by the tightening force of the reinforcement coating body 29 supports the axial core 22, and thus a compressive stress acts between the axial core 22 and the reinforcement coating body 29. In addition, regarding the axial core, a tube for the axial core is filled with carbon powder, a compressive force is applied thereto in an axial direction using a press machine, and a pressure in the diameter direction of the tube for the axial core is increased. The diameter of the tube for the axial core is increased by the pressure, and the reinforcement coating body bears the increase in the diameter of the battery exterior body, whereby it is also possible to exert a compressive stress between the axial core 22 and the reinforcement coating body 29. In a case where dendrites (metallic lithium) are precipitated on the collector in a state in which this compressive stress acts, the dendrites plastically deform, and thus the adhesion between the solid electrolyte layer and the collector is maintained. Therefore, the electrical resistance does not increase, and thus the battery service life can be improved.

(Solid Electrolyte Layer)

The solid electrolyte layer of the present invention includes an inorganic solid electrolyte material. The inorganic solid electrolyte material that configures the solid electrolyte layer is an inorganic solid electrolyte or a mixture of an inorganic solid electrolyte and an active material and generally consists of an inorganic solid electrolyte. Hereinafter, a preferred aspect of the inorganic solid electrolyte will be described. Meanwhile, the active material will be described below.

The inorganic solid electrolyte is a solid electrolyte that is inorganic, and the solid electrolyte refers to a solid-form electrolyte capable of migrating ions therein. The inorganic solid electrolyte is clearly differentiated from organic solid electrolytes (high-molecular-weight electrolytes represented by polyethylene oxide (PEO) or the like and organic electrolyte salts represented by lithium bis(trifluoromethanesulfonyl)imide (LiTFSI)) since the inorganic solid electrolyte does not include any organic substances as a principal ion-conductive material. In addition, the inorganic solid electrolyte is a solid in a static state and is thus, generally, not disassociated or liberated into cations and anions. Due to this fact, the inorganic solid electrolyte is also clearly differentiated from inorganic electrolyte salts of which cations and anions are disassociated or liberated in electrolytic solutions or polymers (LiPF₆, LiBF₄, LiFSI, LiCl, and the like). The inorganic solid electrolyte is not particularly limited as long as the inorganic solid electrolyte has conductivity of ions of metals belonging to Group I or II of the periodic table and is generally a substance not having electron conductivity.

In the present invention, the inorganic solid electrolyte has conductivity of ions of metals belonging to Group I or II of the periodic table. As the inorganic solid electrolyte, it is possible to appropriately select and use solid electrolyte materials that are applied to this kind of products. As the inorganic solid electrolyte, generally, (i) a sulfide-based inorganic solid electrolyte and/or (ii) an oxide-based inorganic solid electrolyte are used.

(i) Sulfide-Based Inorganic Solid Electrolyte

The sulfide-based inorganic solid electrolyte is preferably an inorganic solid electrolyte which contains a sulfur atom (S), has an ion conductivity of a metal belonging to Group I or II of the periodic table, and has an electron-insulating property. The sulfide-based inorganic solid electrolyte is preferably an inorganic solid electrolyte which, as elements, contains at least Li, S, and P and has a lithium ion conductivity, but the sulfide-based inorganic solid electrolyte may also include elements other than Li, S, and P depending on the purposes or cases.

Examples thereof include lithium ion-conductive inorganic solid electrolytes satisfying a composition represented by Formula (I).

Lₐ₁M_{b1}P_{c1}S_{d1}A_{c1} Formula (I)

In the formula, L represents an element selected from Li, Na, and K and is preferably Li. M represents an element selected from B, Zn, Sn, Si, Cu, Ga, Sb, Al, and Ge. A represents an element selected from I, Br, Cl, and F. a1 to e1 represent the compositional ratios among the respective elements, and a1:b1:c1:d1:e1 satisfies 1 to 12:0 to 5:1:2 to 12:0 to 10. Furthermore, a1 is preferably 1 to 9 and more preferably 1.5 to 7.5. b1 is preferably 0 to 3. Furthermore, d1 is preferably 2.5 to 10 and more preferably 3.0 to 8.5. Furthermore, e1 is preferably 0 to 5 and more preferably 0 to 3.

The compositional ratios among the respective elements can be controlled by adjusting the amounts of raw material compounds blended to manufacture the sulfide-based inorganic solid electrolyte as described below.

The sulfide-based inorganic solid electrolytes may be non-crystalline (glass) or crystallized (made into glass ceramic) or may be only partially crystallized. For example, it is possible to use Li-P-S-based glass containing Li, P, and S or Li-P-S-based glass ceramic containing Li, P, and S.

The sulfide-based inorganic solid electrolytes can be manufactured by a reaction of at least two raw materials of, for example, lithium sulfide (Li₂S), phosphorus sulfide (for example, diphosphorus pentasulfide (P₂S₅)), a phosphorus single body, a sulfur single body, sodium sulfide, hydrogen sulfide, lithium halides (for example, LiI, LiBr, and LiCl), or sulfides of an element represented by M (for example, SiS₂, SnS, and GeS₂).

The ratio between Li₂S and P₂S₅ in Li-P-S-based glass and Li-P-S-based glass ceramic is preferably 60:40 to 90:10 and more preferably 68:32 to 78:22 in terms of the molar ratio between Li₂S:P₂S₅. In a case where the ratio between Li₂S and P₂S₅ is set in the above-described range, it is possible to increase the lithium ion conductivity. Specifically, the lithium ion conductivity can be preferably set to 1×10⁻⁴ S/cm or more and more preferably set to 1×10⁻³ S/cm or more. The upper limit is not particularly limited, but realistically 1×10⁻¹ S/cm or less.

As specific examples of the sulfide-based inorganic solid electrolytes, combination examples of raw materials will be described below. Examples thereof include Li—S—P₂S₅, Li₂S—P₂S₅—LiCl, Li₂S—P₂S₅—H₂S, Li₂S—P₂S₅—H₂S—LiCl, Li₂S—LiI—P₂S₅, Li₂S—LiI—Li₂O—P₂S₅, and Li₂S—LiBr—P₂S₅. In addition, examples thereof include Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅——SiS₂—LiCl, Li₂S—P₂S₅—SnS, and Li₂S—P₂S₅—Al₂S₃. Furthermore, examples thereof include Li₂S—GeS₂, Li₂S—GeS₂—ZnS, Li₂S—Ga₂S₃, Li₂S—GeS₂—Ga₂S₃, Li₂S—GeS₂—P₂S₅, Li₂S—GeS₂—Sb₂S₅, and Li₂S—GeS₂—Al₂S₃. In addition, examples thereof include Li₂S—SiS₂, Li₂S—Al₂S₃, Li₂S—SiS₂—Al₂S₃, Li₂S—SiS₂—P₂S₅—LiI, Li₂S—SiS₂—LiI, Li₂S—SiS₂—Li₄SiO₄, Li₂S—SiS₂—Li₃PO₄, Li₁₀GeP₂S₁₂, and the like. Mixing ratios of the respective raw materials do not matter. Examples of a method for synthesizing sulfide-based inorganic solid electrolyte materials using the above-described raw material compositions include an amorphorization method. As the amorphorization method, for example, any of a mechanical milling method, a solution method, or a melting quenching method can be exemplified. This is because these methods can be treated at a normal temperature and it is possible to simplify manufacturing steps.

(ii) Oxide-Based Inorganic Solid Electrolyte

The oxide-based inorganic solid electrolyte is preferably a compound which contains an oxygen atom (O), has an ion conductivity of a metal belonging to Group I or II of the periodic table, and has an electron-insulating property.

As specific compound examples, for example, LiₓₐLa_{ya}TiO₃ [xa=0.3 to 0.7 and ya=0.3 to 0.7] (LLT) is exemplified. In addition, Li_{xb}La_{yb}Zr_{zb}M^{bb}_{mb}O_{nb} (M^{bb} is at least one element selected from Al, Mg, Ca, Sr, V, Nb, Ta, Ti, Ge, In, Sn, or the like, xb satisfies 5≤xb≤10, yb satisfies 1≤yb≤4, zb satisfies 1≤zb≤4, mb satisfies 0≤mb≤2, and nb satisfies 5≤nb≤20.) is exemplified. In addition, Li_{xc}B_{yc}M^{cc}_{zc}O_{nc} (M^{cc} is at least one element selected from C, S, Al, Si, Ga, Ge, In, Sn, or the like, xc satisfies 0≤xc≤5, yc satisfies 0≤yc≤1, zc satisfies 0≤zc≤1, nc satisfies 0≤nc≤6, and xc+yc+zc+nc≠0). Furthermore, Li_{xd}(Al, Ga)_{yd}(Ti, Ge)_{zd}Si_{ad}P_{md}O_{nd} (1 xd≤3, 0≤yd≤1, 0≤zd≤2, 0≤ad≤1, 1≤md≤7, and 3≤nd≤13) and Li₍₃₋₂ₓₑ₎M^{ee}ₓₑD^{ee}O (xe represents a number of 0 or more and 0.1 or less, M^{ee} represents a divalent metal atom, and D^{ee} represents a halogen atom or a combination of two or more halogen atoms.) are exemplified. In addition, Li_{xf}Si_{yf}O_{zf} (1≤xf≤5, 0≤yf≤3, 1≤zf≤10), Li_{xg}S_{yg}O_{zg} (1≤xg≤3, 0≤yg≤2, 1≤zg≤10), Li₃BO₃—Li₂SO₄, Li₂O—B₂O₃—P₂O₅, Li₂O—SiO₂, Li₆BaLa₂O₁₂, Li₃PO_{(4-3/2w)}N_{w} (w satisfies w<1), Li_{3.5}Zn_{0.25}GeO₄ having a lithium super ionic conductor (LISICON)-type crystal structure, La_{0.55}Zn_{0.25}GeO₄ having a perovskite-type crystal structure, LiTi₂P₃O₁₂ having a natrium super ionic conductor (NASICON)-type crystal structure, Li_{1+xh+yl}(Al, Ga)ₓₕ(Ti, Ge)₂₋ₓₕSi_{yh}P_{3-yh}O₁₂ (0≤xh≤1), Li₇La₃Zr₂O₁₂ (LLZ) having a garnet-type crystal structure. In addition, phosphorus compounds containing Li, P and O are also desirable. Examples thereof include lithium phosphate (Li₃PO₄), LIPON in which some of oxygen atoms in lithium phosphate are substituted with nitrogen, LiPOD¹ (D¹ is at least one element selected from Ti, V, Cr, Mn, Fe, Co, Ni, Cu, Zr, Nb, Mo, Ru, Ag, Ta, W, Pt, Au, or the like) and the like. In addition, it is also possible to preferably use LiA¹ON (A¹ represents at least one element selected from Si, B, Ge, Al, C, Ga, or the like) and the like.

The particle diameter (volume-average particle diameter) of the inorganic solid electrolyte is not particularly limited, but is preferably 0.01 μm or more and more preferably 0.1 μm or more. The upper limit is preferably 100 μm or less and more preferably 50 μm or less. Meanwhile, the average particle diameter of the inorganic solid electrolyte particles is measured in the following order. A dispersion liquid of 1% by mass of the inorganic solid electrolyte particles is diluted and adjusted using water (heptane in a case where the inorganic solid electrolyte is unstable in water) in a 20 ml sample bottle. The diluted dispersion specimen is irradiated with 1 kHz ultrasonic waves for 10 minutes and is then immediately used for testing. Data capturing is carried out 50 times using this dispersion liquid specimen, a laser diffraction/scattering-type particle size distribution measurement instrument LA-920 (manufactured by Horiba Ltd.), and a silica cell for measurement at a temperature of 25° C., thereby obtaining the volume-average particle diameter. Regarding other detailed conditions and the like, the description of JIS Z8828:2013 “Particle size analysis-Dynamic light scattering method” is referred to as necessary. Five specimens are produced per level, and the average value thereof is employed.

(Positive Electrode Active Material Layer)

The positive electrode active material layer contains the above-described inorganic solid electrolyte and a positive electrode active material.

A preferred aspect of the positive electrode active material will be described.

—Positive Electrode Active Material —

The positive electrode active material is preferably a positive electrode active material capable of reversibly storing and deintercalating lithium ions. The above-described material is not particularly limited as long as the material has the above-described characteristics and may be transition metal oxides, organic substances, elements capable of being complexed with Li such as sulfur, complexes of sulfur and metal, or the like.

Among these, as the positive electrode active material, transition metal oxides are preferably used, and transition metal oxides having a transition metal element M^{a} (one or more elements selected from Co, Ni, Fe, Mn, Cu, and V) are more preferred. In addition, an element M^{b} (an element of Group I (Ia) of the metal periodic table other than lithium, an element of Group II (IIa), or an element such as Al, Ga, In, Ge, Sn, Pb, Sb, Bi, Si, P, or B) may be mixed into this transition metal oxide. The amount of the element mixed is preferably 0 to 30 mol % of the amount (100 mol %) of the transition metal element M^{a}. The positive electrode active material is more preferably synthesized by mixing the element into the transition metal oxide so that the molar ratio of Li/M^{a} reaches 0.3 to 2.2.

Specific examples of the transition metal oxides include transition metal oxides having a bedded salt-type structure (MA), transition metal oxides having a spinel-type structure (MB), lithium-containing transition metal phosphoric acid compounds (MC), lithium-containing transition metal halogenated phosphoric acid compounds (MD), lithium-containing transition metal silicate compounds (ME), and the like.

Specific examples of the transition metal oxides having a bedded salt-type structure (MA) include LiCoO₂ (lithium cobalt oxide [LCO]), LiNi₂O₂ (lithium nickelate), LiNi_{0.85}C0.10Al_{0.05}O₂ (lithium nickel cobalt aluminum oxide [NCA]), LiNi_{1/3}Co_{1/3}Mn_{1/3}O₂ (lithium nickel manganese cobalt oxide [NMC]), and LiNi_{0.5}Mn_{0.5}O₂ (lithium manganese nickelate).

Specific examples of the transition metal oxides having a spinel-type structure (MB) include LiMn₂O₄ (LMO), LiCoMnO₄, Li₂FeMn₃O₈, Li₂CuMn₃O₈, Li₂CrMn₃O₈, and Li₂NiMn₃O₈.

Examples of the lithium-containing transition metal phosphoric acid compounds (MC) include olivine-type iron phosphate salts such as LiFePO₄ and Li₃Fe₂(PO₄)₃, iron pyrophosphates such as LiFeP₂O₇, and cobalt phosphates such as LiCoPO₄, and monoclinic nasicon-type vanadium phosphate salt such as Li₃V₂(PO₄)₃ (lithium vanadium phosphate).

Examples of the lithium-containing transition metal halogenated phosphoric acid compounds (MD) include iron fluorophosphates such as Li₂FePO₄F, manganese fluorophosphates such as Li₂MnPO₄F, cobalt fluorophosphates such as Li₂CoPO₄F.

Examples of the lithium-containing transition metal silicate compounds (ME) include Li₂FeSiO₄, Li₂MnSiO₄, Li₂CoSiO₄, and the like.

In the present invention, the transition metal oxides having a bedded salt-type structure (MA) is preferred, and LCO, LMO, NCA, or NMC is more preferred.

The shape of the positive electrode active material is not particularly limited, but is preferably a particle shape. The volume-average particle diameter (circle-equivalent average particle diameter) of positive electrode active material particles is not particularly limited. For example, the volume-average particle diameter can be set to 0.1 to 50 μm. In order to provide a predetermined particle diameter to the positive electrode active material, an ordinary crusher or classifier may be used. Positive electrode active materials obtained using a firing method may be used after being washed with water, an acidic aqueous solution, an alkaline aqueous solution, or an organic solvent. The volume-average particle diameter (circle-equivalent average particle diameter) of positive electrode active material particles can be measured using a laser diffraction/scattering-type particle size distribution measurement instrument LA-920 (trade name, manufactured by Horiba Ltd.).

The positive electrode active material may be used singly or two or more positive electrode active materials may be used in combination.

In the case of forming a positive electrode active material layer, the mass (mg) of the positive electrode active material per unit area (cm²) of the positive electrode active material layer (weight per unit area) is not particularly limited and can be appropriately determined depending on the set battery capacity.

The content of the positive electrode active material in the positive electrode active material layer is not particularly limited, but is preferably 10% to 95% by mass, more preferably 30% to 90% by mass, still more preferably 50% to 85% by mass, and particularly preferably 55% to 80% by mass.

The all-solid state secondary battery of the embodiment of the present invention preferably includes a lithium salt, a conductive auxiliary agent, a binder, a dispersant, and the like in the solid electrolyte layer and the positive electrode active material layer. In addition, the solid electrolyte layer may include the above-described positive electrode active material or the negative electrode active material.

As the negative electrode active material, it is possible to use a negative electrode active material that is generally used in all-solid state secondary batteries. Examples thereof include carbonaceous materials, metal oxides such as tin oxide, silicon oxide, metal complex oxides, a lithium single body, lithium alloys such as lithium aluminum alloys, metals capable of forming alloys with lithium such as Sn, Si, Al, and In and the like.

[Collector (Metal Foil)]

The positive electrode collector and the negative electrode collector are preferably an electron conductor.

In the present invention, there are cases in which any or both of the positive electrode collector and the negative electrode collector will be simply referred to as the collector.

As a material forming the positive electrode collector, aluminum, an aluminum alloy, stainless steel, nickel, titanium, or the like, and furthermore, a material obtained by treating the surface of aluminum or stainless steel with carbon, nickel, titanium, or silver (a material forming a thin film) is preferred. Among these, aluminum and an aluminum alloy are more preferred.

As a material forming the negative electrode collector, aluminum, copper, a copper alloy, stainless steel, nickel, titanium, or the like, and furthermore, a material obtained by treating the surface of aluminum, copper, a copper alloy, or stainless steel with carbon, nickel, titanium, or silver is preferred. Among these, aluminum, copper, a copper alloy, or stainless steel is more preferred.

Regarding the shape of the collector, generally, collectors having a film sheet-like shape are used, but it is also possible to use net-shaped collectors, punched collectors, compacts of lath bodies, porous bodies, foaming bodies, or fiber groups, and the like.

The thickness of the collector is not particularly limited, but is preferably 1 to 500 μm. In addition, the surface of the collector is preferably provided with protrusions and recesses by means of a surface treatment.

In the present invention, a functional layer, member, or the like may be appropriately interposed or disposed between the respective layers of the negative electrode collector, the negative electrode active material layer, the solid electrolyte layer, the positive electrode active material layer, and the positive electrode collector or on the outside thereof. In addition, the respective layers may be composed of a single layer or multiple layers.

<Method for Manufacturing All-Solid State Secondary Battery>

A preferred example of a method for manufacturing an all-solid state secondary battery of an embodiment of the present invention will be described, but the method for manufacturing an all-solid state secondary battery of the embodiment of the present invention is not limited to this form.

A composition including a component that configures the positive electrode active material layer (composition for a positive electrode) is applied onto both surfaces of a base material (for example, a metal foil that serves as the collector) to form positive electrode active material layers, thereby producing positive electrode sheets for an all-solid state secondary battery. Next, a composition containing at least the inorganic solid electrolyte material is applied to the surfaces of both positive electrode active material layers to form solid electrolyte layers. The solid electrolyte layer and/or the positive electrode active material layer also preferably include sulfur and/or modified sulfur.

Next, a negative collector (metal foil) is overlaid on one solid electrolyte layer and wound around the axial core, whereby it is possible to obtain a battery element member having a structure in which the solid electrolyte layer is interposed between the positive electrode active material layer and the negative electrode collector. In addition, the battery element member is disposed in a battery exterior body and sealed.

In the above-described step, in a case where sulfur and/or modified sulfur are added to the solid electrolyte layer or the positive electrode active material layer, it is preferable to heat the battery exterior body in which the all-solid state secondary battery is sealed in a temperature range of 200° C. or lower after the disposition of a reinforcement coating body described below. Due to this heating, sulfur and/or modified sulfur that are harder than dendrites are thermally fused and are capable of flowing into a void that is generated in the solid electrolyte layer through the capillary action, and it is possible to prevent the dendrites from entering the voids and growing in the voids. The dendrites reaching a positive electrode cause an internal short circuit, and thus at least the solid electrolyte layer preferably contains sulfur and/or modified sulfur.

After that, a reinforcement coating body is disposed on a side surface outer circumference of the battery exterior body. Therefore, a desired all-solid state secondary battery can be produced.

According to the above-described manufacturing method, the solid electrolyte layer and/or the positive electrode active material layer sufficiently prevent the growth of metal that is precipitated in a dendrite shape on the negative electrode collector, plastically deform the metal, and the adhesion between the negative electrode collector and the precipitated metal can be enhanced. As a result, it is possible to prevent an increase in the electrical resistance and suppress the shortening of the battery service life.

Before the disposition of the battery element member in the battery exterior body 23, the battery element member may be shaped to a cylindrical shape and then heated in a temperature range of 200° C. or lower.

The reinforcement coating body 29 is produced by winding the carbon fiber filament impregnated with the resin without generating a void on the side surface outer circumference of the battery exterior body 23 so as to obtain the above-described tension (winding force). Regarding the winding start point and the winding end point, the tied portions are fixed using an instant adhesive in a state in which the points are tied using a stainless steel wire. The carbon fiber filament is preferably wound so that the width We becomes longer than the width We of the battery element member 21 in the battery longitudinal direction. The carbon fiber filament may be wound in multiple layers.

Meanwhile, in the reinforcement coating body 29, in a case where the carbon fiber filament is wound around the side surface outer circumference of the battery exterior body 23 in a state in which the temperature is lowered to be lower than a normal temperature (for example, 23° C.), the carbon fiber filament expands less than at a normal temperature. In addition, in a case where the temperature returns to the normal temperature, the carbon fiber filament contracts less than at the times of being wound, and thus a stress acts on the wound carbon fiber filament in the inside direction of the battery exterior body 23, and the carbon fiber filament becomes loose.

The above-described normal temperature generally refers to a temperature of just or approximately 23° C., for example, a temperature range of 20° C. to 25° C. Here, as an example, the normal temperature is set to 23° C.

Another method for manufacturing the reinforcement coating body will be described below. The reinforcement coating body can be produced by winding the above-described CFRP tape around a member having the same dimensions as the battery exterior body, solidifying the tape with a resin, and then removing the tape from the member. As the resin, an acrylic resin, a urethane resin, an epoxy resin, or the like is preferably used, and an epoxy resin is more preferred. For example, in a case where the battery exterior body has a cylindrical shape, the Miler diameter of the reinforcement coating body is formed to be approximately 0 μm to 20 μm larger than the contour of the battery exterior body, and thus there is a void between the inner diameter of the reinforcement coating body and the contour of the battery exterior body, and thus it is possible to fit the reinforcement coating body onto the battery exterior body. Meanwhile, at the time of winding the CFRP tape around the member, it is not necessary to wind, the tape by particularly applying tension to the CFRP tape.

(Methods for Forming Individual Layers)

In the manufacturing of the all-solid state secondary battery of the embodiment of the present invention, methods for forming the solid electrolyte layer and the active material layer are not particularly limited and can be appropriately selected. Examples thereof include coating (preferably wet-type coating), spray coating, spin coating, dip coating, slit coating, stripe coating, and bar coating.

At this time, a drying treatment may be carried out after the application of the composition, and a drying treatment may be carried out after the composition is applied to multiple layers. The drying temperature is not particularly limited. The lower limit is preferably 30° C. or higher, more preferably 60° C. or higher, and still more preferably 80° C. or higher, and the upper limit is preferably 300° C. or lower, more preferably 250° C. or lower, and still more preferably 200° C. or lower. In a case where the compositions are heated in the above-described temperature range, it is possible to remove the dispersion medium (C) and form a solid state. In addition, the temperature is not excessively increased, and the respective members of the all-solid state secondary battery are not impaired, which is preferable. Therefore, in the all-solid state secondary battery, excellent total performance is exhibited, and it is possible to obtain a favorable bonding property.

(Initialization)

The all-solid state secondary battery manufactured as described above is preferably initialized after the manufacturing or before the use. A method for initialization is not particularly limited, and it is possible to initialize the all-solid state secondary battery by, for example, carrying out initial charging and discharging in a state in which the pressing pressure is increased and then releasing the pressure up to a pressure at which the all-solid state secondary battery is ordinarily used.

<Usages of All-Solid State Secondary Battery>

The all-solid state secondary battery of the embodiment of the invention can be applied to a variety of usages. Application aspects are not particularly limited, and the all-solid state secondary battery is mounted in electronic devices. As the electronic devices, notebook computers, pen-based input personal computers, mobile personal computers, e-book players, mobile phones, cordless phone handsets, pagers, handy terminals, portable faxes, mobile copiers, portable printers, and the like are exemplified. In addition, the all-solid state secondary battery is mounted in audio and video devices such as headphone stereos, video movies, liquid crystal televisions, portable CD players, mini disc players, portable tape recorders, and radios. Furthermore, as devices in which the all-solid state secondary battery is mounted, handy cleaners, electric shavers, transceivers, electronic notebooks, desktop electronic calculators, memory cards, backup power supplies, and the like are exemplified. Additionally, examples of consumer usages include automobiles, electric vehicles, motors, lighting equipment, toys, game devices, road conditioners, watches, strobes, cameras, medical devices (pacemakers, hearing aids, shoulder massage devices, and the like), and the like. Furthermore, the all-solid state secondary battery can be used for a variety of military usages and universe usages. In addition, the all-solid state secondary battery can also be combined with solar batteries.

Among these, the all-solid state secondary battery is preferably applied to applications demanding high-capacity and high-rate discharge characteristics. For example, in electricity storage facilities and the like that are expected to have a large capacity in the future, high safety becomes essential, and, furthermore, the satisfaction of battery performance is also required. In addition, in electric vehicles and the like, a high-capacity secondary battery is mounted, and, at home, uses that are daily charged are imagined. According to the present invention, it is possible to preferably cope with the above-described use forms and exhibit the excellent effect,

### EXAMPLES

The present invention will be described in more detail on the basis of examples, but the present invention is not limited to these examples.

### Reference Example 1

### Synthesis of Inorganic Solid Electrolyte

In a glove box under an argon atmosphere (dew point: −70° C.), lithium sulfide (Li₂S, manufactured by Aldrich-Sigma, Co. LLC. Purity: >99.98%) (4.84 g) and diphosphorus pentasulfide (P₂S₅, manufactured by Aldrich-Sigma, Co. LLC. Purity: >99%) (7.80 g) were respectively weighed and injected into an agate mortar. The molar ratio between Li₂S and P₂S₅ was 75:25 (Li₂S:P₂S₅). The components were mixed on the agate mortar using an agate muddler for five minutes.

Sixty six zirconia beads having a diameter of 5 mm were injected into a 45 mL zirconia container (manufactured by Fritsch Japan Co., Ltd.), the full amount of the mixture was injected thereinto, and the container was completely sealed in an argon atmosphere. The container was set in a planetary ball mill P-7, and mechanical milling was carried out at 25° C. and a rotation speed of 510 rpm for 20 hours, thereby obtaining yellow powder of a sulfide-based inorganic solid electrolyte (Li/P/S glass; hereinafter, also referred to as “LPS”) (12.4 g).

The volume-average particle diameter of the obtained LPS was measured using a laser diffraction/scattering-type particle size distribution measurement instrument LA-920 (trade name, manufactured by Horiba Ltd.) and found out to be 8 μm.

### Reference Example 2

### Preparation of Mixture of Sulfur and Sulfur-Based Inorganic Solid Electrolyte

In a glove box under an argon atmosphere (dew point: −70° C.), sulfur (S, manufactured by Aldrich-Sigma, Co. LLC. Purity: >99.98%) (0.8 g) and the LPS (6.2 g) were respectively weighed and injected into an agate mortar. The mass ratio between sulfur and LPS was 88:12 (LPS:S), and the volume ratio was 100:11 (LPS:S). The components were mixed on the agate mortar using an agate muddler for 10 minutes.

### Manufacturing Example

### Production of All-Solid State Secondary Battery

<Production of Positive Electrode Sheet for All-Solid State Secondary Battery>

One hundred eighty zirconia beads having a diameter of 5 mm were injected into a 45 mL zirconia container (manufactured by Fritsch Japan Co., Ltd.), and LPS synthesized above (2.0 g), styrene butadiene rubber (product code: 182907, manufactured by Aldrich-Sigma, Co. LLC.) (0.1 g), and octane (22 g) as a dispersion medium were injected thereinto. After that, the container was set in a planetary ball mill P-7 manufactured by Fritsch Japan Co., Ltd., and the components were stirred at a temperature of 25° C. and a rotation speed of 300 rpm for two hours. After that, a positive electrode active material LiNi_{0.85}Co_{0.10}Al_{0.05}O₂ (lithium nickel cobalt aluminum oxide) (7.9 _{g}) was injected into the container, again, the container was set in the planetary ball mill P-7, and the components were continuously mixed together at a temperature of 25° C. and a rotation speed of 100 rpm for 15 minutes. A composition for a positive electrode was obtained as described above.

Next, according to an ordinary method, the composition (composition for a positive electrode) including the components that configured a positive electrode active material obtained above was applied to both surfaces of a 20 μm-thick aluminum foil that serves as a collector using a Baker-type applicator and heated at 80° C. for two hours, thereby drying the composition for a positive electrode. After that, the dried composition for a positive electrode was heated (at 120° C.) and pressurized (at 600 MPa for one minute) using a heat press machine so as to obtain a predetermined density. A positive electrode sheet for an all-solid state secondary battery having a positive electrode active material layer having a film thickness of 110 μm was produced as described above.

Next, the mixture of sulfur and an inorganic solid electrolyte prepared in Reference Example 2 was dispersed in toluene at normal temperature after 2% by mass of styrene butadiene rubber was added to the mixture, thereby obtaining a coating fluid having a solid content of 20% by mass. This coating fluid was applied to both surfaces of the positive electrode sheet at normal temperature by bar coating and dried at 120° C., thereby laminating solid electrolyte layers having a width of 50 mm and a film thickness of 100 μm on both surfaces.

Next, a 50 mm-wide stainless steel (SUS) foil that served as a negative electrode collector was overlaid on one solid electrolyte layer, and this laminate sheet was wound so that the negative electrode collector came into contact with the outer circumference of an axial core consisting of a stainless steel cylinder. The cylinder was produced by providing a slit on a cylinder having a diameter of 18 mm, a thickness of 0.1 mm, and a length of 65 mm so that the cylinder could be broken from the inside by pressure.

After that, the cylinder was put into an exterior case of a stainless steel cylinder having a diameter of 26 mm, a thickness of 0.1 mm, and a length of 65 mm.

Furthermore, a 1 mm-thick reinforcement coating body around which a carbon film filament (a bundle of 1,000 monofilaments having a diameter of 7 μm) impregnated with a resin was wound in a hoop shape was fitted on the outside of the exterior case.

After that, the axial core of the cylinder was filled with active coal, the active coal was compressed using a press machine from both sides of the axial core of the cylinder at a pressure of 24 Pa, and the width of the slit on the axial core of the cylinder was broadened, thereby increasing the diameter of the axial core of the cylinder. This increase in the diameter applied a confining pressure of 0.5 MPa or more between the exterior case and the core of the cylinder. The confining pressure was confirmed by putting a pressure measurement film (PRESCALE) into the exterior case.

Part of the positive electrode collector was peeled off and brought into contact with the inside of the battery exterior case, thereby conducting electricity.

The negative electrode collector was brought into contact with the outer circumference of the axial core, thereby conducting electricity. Therefore, it is possible to remove a current to the outside.

In a state in which the reinforcement coating body was disposed on a side circumferential portion of the battery exterior body, the laminate sheet was heated on a hot plate at 150° C. for 30 minutes, and sulfur was thermally fused and then cooled to seal the exterior case, thereby obtaining an all-solid state secondary battery A.

All-solid state secondary batteries B to E were obtained under the same conditions except for the fact that some of the conditions were changed as shown in the following table.

### Testing Example 1

### Charge and Discharge Cycle Characteristic Test

(Testing Method)

A charge and discharge cycle characteristic test was carried out under the following conditions using all-solid state secondary batteries produced in the same manner as in the above-described manufacturing example (one all-solid state secondary battery having an inorganic insulating coated body and one all-solid state secondary battery not having an inorganic insulating coated body). In addition, the percentage of the discharge capacity in the second cycle of the discharge capacity in the first cycle in charge and discharge cycles (discharge capacity retention (%)=100×[discharge capacity in second cycle/discharge capacity in first cycle]) was computed.

As charge and discharge conditions, the temperature of the measurement environment was set to 30° C., the current density was set to 0.09 ma/cm² (equivalent to 0.05 C), the voltage was set to 4.2 V, and constant-current charge and discharge was carried out.

(Determination Standards)

A case where the discharge capacity retention in the second cycle is 90% or more: A

A case where the discharge capacity retention in the second cycle is 80% or more and less than 90%: B

A case where the discharge capacity retention in the second cycle is less than 80%: C

Hydrogen sulfide (H₂S) gas generation test

(Testing Method)

The all-solid state secondary battery that had been subjected to one cycle of the charge and discharge cycle characteristic test was put into a plastic bag having a capacity of 1 L together with a H₂S gas monitor (GX-2009 (trade name) manufactured by Riken Keiki Co., Ltd.). In addition, the plastic bag was sealed in a state in which the capacity was set to 1 L, and the generation rate of slightly leaking H₂S gas for one minute after the H₂S concentration reached 10 ppm.

As charge and discharge conditions, the temperature of the measurement environment was set to 30° C., the current density was set to 0.09 ma/cm² (equivalent to 0.05 C), the voltage was set to 4.2 V, and constant-current charge and discharge was carried out.

(Determination Standards)

A case where the generation rate of H₂S after one cycle is slower than 0.5 ppm/minute: A

A case where the generation rate of H₂S after one cycle is 0.5 to 2 ppm/minute B

A case where the generation rate of H₂S after one cycle is faster than 2 ppm/minute C

The results are shown in the following table.

TABLE 1

| | | Result of | Result of |
|---|---|---|---|
| | | Testing | Testing |
| Kind of battery | Details of battery condition | Example 1 | Example 2 |
| All-solid state | Reinforcement coating body provided | 95% | Evaluation A |
| secondary battery A | Axial core pressed (compressive stress: 0.5 MPa) | Evaluation A | |
| (Example 1) | Solid electrolyte layer: Reference Example 2 | | |
| | (containing sulfur) | | |
| All-solid state | Reinforcement coating body provided | 87% | Evaluation A |
| secondary battery B | Axial core pressed (compressive stress: 0.5 MPa) | Evaluation B | |
| (Example 2) | Solid electrolyte layer: Reference Example 1 | | |
| All-solid state | Reinforcement coating body provided | 42% | Evaluation A |
| secondary battery C | Axial core not pressed (compressive stress: 0 MPa) | Evaluation C | |
| (Comparative Example 1) | Solid electrolyte layer: Reference Example 2 | | |
| | (containing sulfur) | | |
| All-solid state | Reinforcement coating body not provided | 41% | Evaluation B |
| secondary battery D | Axial core not pressed (compressive stress: 0 MPa) | Evaluation C | |
| (Comparative Example 2) | Solid electrolyte layer: Reference Example 2 | | |
| | (containing sulfur) | | |
| All-solid state | Reinforcement coating body not provided | 37% | Evaluation C |
| secondary battery E | Axial core not pressed (compressive stress: 0 MPa) | Evaluation C | |
| (Comparative Example 3) | Solid electrolyte layer: Reference Example 1 | | |

As shown in the table, it was found that, in a case where the reinforcement coating body is provided and a compressive stress is provided between the battery exterior body and the battery element member by pressing the axial core, the discharge capacity retention is increased, and the generation of hydrogen sulfide is suppressed.

The present application claims priority on the basis of JP2017-047773 filed on Mar. 13, 2017 in Japan, the content of which is incorporated herein by reference.

### EXPLANATION OF REFERENCES

1: negative electrode collector

2: negative electrode active material layer

3: solid electrolyte layer

4: positive electrode active material layer

5: positive electrode collector

6: operation portion

21: battery element member

21a: solid electrolyte layer

21b: positive electrode collector

21c: positive electrode active material layer

21d: negative electrode collector

22: axial core

23: battery exterior body

29: reinforcement coating body

30: all-solid state secondary battery

What is claimed is:

1. An all-solid state secondary battery comprising:
a battery element member having a collector, a solid electrolyte layer, and a positive electrode active material layer;
an axial core having the battery element member disposed on a side surface outer circumference; and
a battery exterior body that is configured to store the battery element member and the axial core,
wherein a reinforcement coating body is provided on the side surface outer circumference of the battery exterior body, to press in the inside direction on the side surface outer circumference, and,
in a discharged state, a compressive stress of 0.5 MPa or more at 25° C. is provided between the axial core and the battery element member and between the battery exterior body and the battery element member.

2. The all-solid state secondary battery according to claim 1,
wherein the reinforcement coating body has a carbon fiber.

3. The all-solid state secondary battery according to claim 1,
wherein the reinforcement coating body is wound around the side surface outer circumference of the battery exterior body.

4. The all-solid state secondary battery according to claim 1,
wherein an inner diameter of the reinforcement coating body is constant from a battery positive electrode side through a battery negative electrode side, and a width of the reinforcement coating body in a longitudinal direction of the axial core is longer than a width of the battery element member.

5. The all-solid state secondary battery according to claim 1,
wherein the axial core includes a carbon material.

6. The all-solid state secondary battery according to claim 1,
wherein the solid electrolyte layer and/or the positive electrode active material layer contain sulfur and/or modified sulfur.

7. A method for manufacturing the all-solid state secondary battery according to claim 6, the method comprising:
(a) a step of disposing the battery element member in the battery exterior body;
(b) a step of disposing the reinforcement coating body on the side surface outer circumference of the battery exterior body; and
(c) a step of heating the battery exterior body on which the reinforcement coating body is disposed in a temperature range of 200° C. or lower to thermally fuse the sulfur and/or the modified sulfur.

8. The method for manufacturing the all-solid state secondary battery according to claim 7,
wherein the heating is carried out after the battery element member is shaped to a cylindrical shape.
